(19) United States
(12) Patent Application Publication
(10) Pub. No.: US 2024/0353596 A1
(43) Pub. Date: Oct. 24, 2024

(54) ILLUMINATION APPARATUS

(71) Applicant: AMS-OSRAM ASIA PACIFIC PTE. LTD., Singapore (SG)

(72) Inventors: Lorenzo TONSA, Zurich (CH); Daniele PERENZONI, Rovereto (IT); Francesco GARBELLI, Arcore (IT); Chuan Wei WONG, Singapore (SG); Alessandro PIOTTO, Thalwil (CH)

(21) Appl. No.: 18/685,508

(22) PCT Filed: Jun. 28, 2022
(86) PCT No.: PCT/SG2022/050445

§ 371 Date: Feb. 22, 2024

(30) Foreign Application Priority Data
Aug. 30, 2021 (GB) 2112351.8

(51) Int. Cl. G02B 3/00; G01B 11/25; G01S 7/481; G01S 17/89

(52) U.S. Cl. CPC G02B 3/0056; G01B 11/2513; G01S 7/4813; G01S 7/4815; G01S 17/89

(57) ABSTRACT

An illumination apparatus includes a micro lens array (MLA) including periodically arranged micro lenses. The apparatus also includes an array of periodically arranged first radiation-emitting elements disposed at a first distance from the MLA and configured to generate, in cooperation with the MLA, a structured light pattern. The apparatus includes a plurality of second radiation-emitting elements disposed at a second distance from the MLA and arranged to avoid matching any periodicity of the periodically arranged micro lenses and configured to generate, in cooperation with the MLA, a beam for flood illumination. The first distance is greater than the second distance.

### CROSS-REFERENCE TO RELATED APPLICATIONS

The present application is a U.S. National Stage Application of International Application PCT/SG2022/050445, filed Jun. 28, 2022, and claims the priority of the United Kingdom Patent Application GB 2112351.8, filed Aug. 30, 2021; the entire disclosures of the above-listed applications are hereby explicitly incorporated by reference.

### FIELD

The present disclosure relates to the field of illumination apparatuses for use in depth mapping applications, and relates in particular to an illumination apparatus for generating a beam for flood illumination and also for generating structured light patterns.

### BACKGROUND

Depth mapping of a scene, also known as 3-dimensional (3D) mapping, is commonly employed by electronic devices, for example smartphones, tablet devices, games consoles and laptop computers.

In some examples, depth mapping of a scene may be used for security purposes, such as to enable access to a resource on an electronic device or unlock the electronic device based on 3D facial recognition. In some examples, electronic devices may also comprise image-sensing devices such as cameras, wherein a depth-map of a scene may be used to improve image-capturing capabilities of the image-sensing devices.

Several techniques for depth mapping are known. For example, stereo-vision cameras may be employed to determine a depth map of a scene based upon disparities between images captured by a plurality of cameras. Some depth mapping techniques may include illumination of a scene, wherein characteristics of the illumination may be used to determine a depth-map of the scene.

In some examples, structured light, e.g. a light pattern, may be used. Therein, structured light may be projected onto a scene and a pattern created in the scene by the projected structured light makes it possible to distinguish features of the scene according to their distance from the structured light-emitting apparatus. That is, an image of the structured light as projected onto a scene may be compared to a reference pattern, and disparities between the image and the reference pattern may be used to determine a depth map of the scene.

In some examples, a general illumination of the scene may also be required. In contrast to structured light illuminators, flood illuminators are known to provide a generally uniform illumination of a scene.

In some examples, a flood illuminator may be used to illuminate a scene and detect presence of an object, such as a person, in front of a sensor, and a structured light illuminator may be used to illuminate a scene with a unique dot pattern, thereby enabling a 3D reconstruction of the scene.

However, implementations of both flood illuminators and structured light illuminators in an electronic device may increase an overall cost, complexity and size of the device. Furthermore, recent trends in electronic device design, and in particular in the design of portable devices such as smartphones, are towards increased levels of miniaturization and decreased overall cost.

It is therefore also desirable to provide a 3D mapping solution that is suitable for use in electronic devices such as smartphones, smart-watches, tablet devices, games consoles and laptop computers, wherein the solution does not substantially increase a cost, complexity and/or size of the electronic device.

It is therefore an aim of at least one embodiment of at least one aspect of the present disclosure to obviate or at least mitigate at least one of the above identified shortcomings.

### SUMMARY

The present disclosure in the field of illumination apparatuses for use in depth mapping applications, and relates in particular to an illumination apparatus for generating a beam for flood illumination and also for generating structured light patterns.

According to a first aspect of the disclosure there is provided an illumination apparatus comprising: a micro lens array (MLA) comprising periodically arranged micro lenses; an array of periodically arranged first radiation-emitting elements disposed at a first distance from the MLA and configured to generate, in cooperation with the MLA, a structured light pattern; and a plurality of second radiation-emitting elements disposed at a second distance from the MLA and arranged to avoid matching any periodicity of the periodically arranged micro lenses and configured to generate, in cooperation with the MLA, a beam for flood illumination. The first distance is greater than the second distance.

By integrating both the first radiation-emitting elements for generating the structured light pattern and the second radiation-emitting elements for generating the beam for flood illumination into a single apparatus, e.g. a single package, an overall size of the illumination apparatus may be reduced relative to previous solutions that implement discrete flood illuminators and structured light pattern illuminators.

By reducing an overall size of the apparatus, a materials cost associated with manufacturing the apparatus may be reduced. Furthermore, a footprint required for the apparatus, e.g. a footprint on a printed circuit board, may also be reduced, thereby reducing an overall system costs.

By having only a single MLA for generation of both a structured light pattern and a beam for flood illumination, a complexity of the apparatus may be reduced, and thereby assembly costs and times may be reduced accordingly.

Furthermore, by having only a single MLA for generation of both a structured light pattern and a beam for flood illumination, design tolerance control may be improved. That is, by integrating flood illumination and structured light illumination functionality into a single apparatus, requirements for precise relative location of discrete components for discrete flood illuminators and structured light pattern illuminators are mitigated.

The disclosed apparatus may be implemented on electronic devices, for example smartphones, wherein only a single aperture is required in a housing of the electronic device for both structured light and flood illumination, compared to previous devices which may require two apertures. Furthermore, a size of an aperture required for the disclosed illumination apparatus would be smaller than a total size of two apertures required in previous electronic devices.

By having the plurality of second radiation-emitting elements arranged to avoid matching any periodicity, e.g. pitch, of the periodically arranged micro lenses, substantial fringes and/or high contrast regions in the beam for flood illumination may be avoided. Furthermore, such an arrangement enables a single MLA to be used for both flood illumination and generation of structured light.

That is, for an illumination apparatus comprising an MLA comprising microlenses regularly arranged with a microlens pitch P, and a plurality of radiation-emitting elements arranged on a common plane at a distance D from the MLA, wherein each radiation-emitting element is configured to emit radiation having wavelength L, a particularly high contrast structured light pattern may be achieved when:

$${P}^{2} = 2 LD / N \qquad Equation ( 1 )$$

and where N is a positive integer. Thus, by having the first distance greater than the second distance, e.g. the second radiation-emitting elements closer to the MLA than the first radiation-emitting elements, this relationship between P, D and N may be avoided for the second radiation-emitting elements, thus avoiding any substantial fringes and/or high contrast regions in the beam for flood illumination. That is, the second distance may be selected such that the relationship between P, D and N defined by Equation (1) is not met for the second radiation-emitting elements, thereby improving a uniformity of the flood illumination.

The first distance may be selected such that the relationship between P, D and N for the first radiation-emitting elements as defined by Equation (1) is met. Therefore, the array of periodically arranged first radiation-emitting elements disposed at a first distance from the MLA may be configured to generate, in cooperation with the MLA, a structured light pattern comprising fringes and/or high contrast regions.

The illumination apparatus may comprise a thermally conductive spacer wherein the plurality of second radiation-emitting elements are disposed in heat-transfer relation to the spacer. The spacer may define the second distance.

The thermally conductive spacer may conduct heat away from the second radiation-emitting elements, thus optimising an operation of the second radiation-emitting elements. Heat may, for example, be conducted into a further substrate onto which the spacer is mounted, as described in more detail below.

The spacer may be formed from a ceramic material.

A ceramic material provides both sufficient heat dissipation and relatively high freedom in design shape. For example, a design of the spacer may be selected to define the second distance as required. Furthermore, a ceramic material may provide sufficient electrical isolation, and may be suitable as a substrate upon which electrical contacts may be formed, as described in more detail below.

In some embodiments, the spacer may be formed from a High-Temperature Co-fired Ceramic (HTCC).

In some embodiments, the spacer may comprise at least one conductive via extending through the spacer.

In some embodiments, the spacer may comprise a Printed Circuit Board (PCB)

The spacer may comprise an aperture disposed over the array of first radiation-emitting elements such that radiation emitted by the first radiation-emitting elements propagates through the aperture towards the MLA.

The spacer may be designed function as an optical baffle, limiting a field of illumination of the first radiation-emitting elements, as may be required by particular design specification.

The spacer may extend over an integrated circuit (IC), such that the plurality of second radiation-emitting elements are disposed over the IC.

By extending the spacer over the IC, a compact and highly integrated apparatus may be assembled by effectively stacking the second radiation-emitting elements over the IC.

Furthermore, the spacer and the IC may collectively provide a thermally conductive path for sinking heat from the second radiation-emitting elements

In some embodiments, the spacer and the IC may be coupled by a thermal interface material, for example a thermal paste or silicone thermal compound.

The spacer may be an IC.

The IC may be configured to drive the array of periodically arranged radiation-emitting elements and/or the plurality of first and/or second radiation-emitting elements.

By using an IC as the spacer, the IC may serve dual purposes of both driving the array of periodically arranged first radiation-emitting elements and/or the plurality of second radiation-emitting elements, and also defining the second distance. Such dual functionality of the IC may enable assembly of a particularly small and compact apparatus

The illumination apparatus may comprise a substrate. The spacer may provide at least one electrical connection between at least one electrically conductive element formed on the substrate and the plurality of second radiation-emitting elements.

The spacer may comprise one or more metal layers. For example, a metal layer on an upper surface of the spacer may define bond pads for coupling to one or more electrical components, such as the plurality of second radiation-emitting elements. A metal layer on a lower surface of the spacer may define bond pads for coupling the spacer to another component, such as a substrate forming part of the illumination apparatus. One or more vias may extend through the spacer and may connect a metal layer on an upper surface of the spacer to a metal layer on the lower surface of the spacer.

The spacer may comprise one or more intermediate metal layers.

The array of periodically arranged first radiation-emitting elements may comprise radiation-emitting elements having a pitch corresponding to an integer N multiple or a 1/N multiple of a pitch of the MLA.

The array of periodically arranged first radiation-emitting elements may comprise radiation-emitting elements having a first pitch corresponding to an integer N multiple or a 1/N multiple of a second pitch of the MLA.

By matching a periodicity of the MLA, or an integer multiple of the MLA, structured light patterns generated by each radiation-emitting element may precisely overlap to increase an intensity of a total structured light pattern emitted by the illumination apparatus.

By matching a 1/N multiple of the pitch of the MLA, the structured light pattern may comprise more dots than there are lenses in the MLA. For example, if the first radiation-emitting elements are arranged with a pitch corresponding to half the pitch of the MLA in both an x-direction and an orthogonal y-direction, a structured light pattern comprising four times as many dots as there are lenses in the MLA may be generated.

The plurality of second radiation-emitting elements may be periodically arranged with a pitch different to a pitch of the MLA in at least a first direction and a second direction orthogonal to the first direction.

The plurality of second radiation-emitting elements may be periodically arranged with a third and/or fourth pitch different to a/the second pitch of the MLA in at least a first direction and a second direction orthogonal to the first direction.

By arranging the plurality of second radiation-emitting elements such that a pitch of the MLA is not matched, a relatively uniform beam of illumination without substantial fringes and/or high contrast regions may be generated that is suitable for flood illumination.

The plurality of second radiation-emitting elements may be arranged in a regular periodic array that is rotated relative to the periodically arranged micro lenses of the MLA.

By rotating the plurality of second radiation-emitting elements relative to the periodically arranged micro lenses of the MLA, any matching between the periodicity of MLA and the second radiation-emitting elements may be avoided. This may enable the second radiation-emitting elements to be provided as a regular periodic array which is generally a simpler design to achieve, yet substantial fringes and/or high contrast regions in emitted radiation may be avoided.

The array of periodically arranged first radiation-emitting elements disposed at the first distance may be configured to generate a structured light pattern comprising an array of dots or lines on a target.

By organising the radiation-emitting elements in particular patterns, the structured light pattern may comprise desired shapes, e.g. dots or lines.

Each radiation-emitting element may be a Vertical Cavity Surface Emitting Laser (VCSEL).

In some embodiments, each radiation-emitting element may be configured to emit infrared radiation.

The plurality of second radiation-emitting elements may be provided as a monolithic device. That is, the plurality of second radiation-emitting elements may be provided as an array of radiation-emitting elements on a single substrate, e.g. a silicon substrate.

The illumination apparatus may be provided in combination with a housing to define a device. The device may be, for example, any of: a smartphone; a tablet device; a communications device; a personal computer; a wearable electronic device; an e-lock device; a security device; a biometric identification device; or a gaming device.

The housing may enclose the illumination apparatus. The illumination apparatus may be configured to emit the structured light pattern and the beam for flood illumination through a single aperture or window in the housing.

Such a housing may be simpler and cheaper to manufacture, and generally more aesthetically pleasing to a user.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE DRAWINGS

These and other aspects of the present disclosure will now be described, by way of example only, with reference to the accompanying drawings, wherein:

FIG. 1 depicts a block diagram of a known illumination assembly comprising a flood illumination apparatus and a structured light illumination apparatus;

FIG. 2 depicts a block diagram of an illumination apparatus according to an embodiment of the disclosure;

FIG. 3 depicts a cross-sectional view of an illumination apparatus according to a further embodiment of the disclosure;

FIG. 4 depicts a perspective, cut-away view of the illumination apparatus of FIG. 3;

FIG. 5 depicts a perspective, cut-away view of an illumination apparatus according to a further embodiment of the disclosure;

FIG. 6 depicts a micro lens array (MLA) comprising periodically arranged micro lenses and an array of radiation-emitting elements, according to an embodiment of the disclosure;

FIG. 7 depicts a depicts a micro lens array (MLA) comprising periodically arranged micro lenses and an array of radiation-emitting elements, according to a further embodiment of the disclosure';

FIG. 8 depicts a depicts a micro lens array (MLA) comprising periodically arranged micro lenses and a plurality of randomly distributed radiation-emitting elements, according to an embodiment of the disclosure;

FIG. 9 depicts a perspective view of a spacer for an illumination apparatus, according to an embodiment of the disclosure;

FIG. 10 depicts a further perspective view of the spacer of FIG. 9; and

FIG. 11 depicts a device comprising an illumination apparatus according to an embodiment of the disclosure.

### DETAILED DESCRIPTION

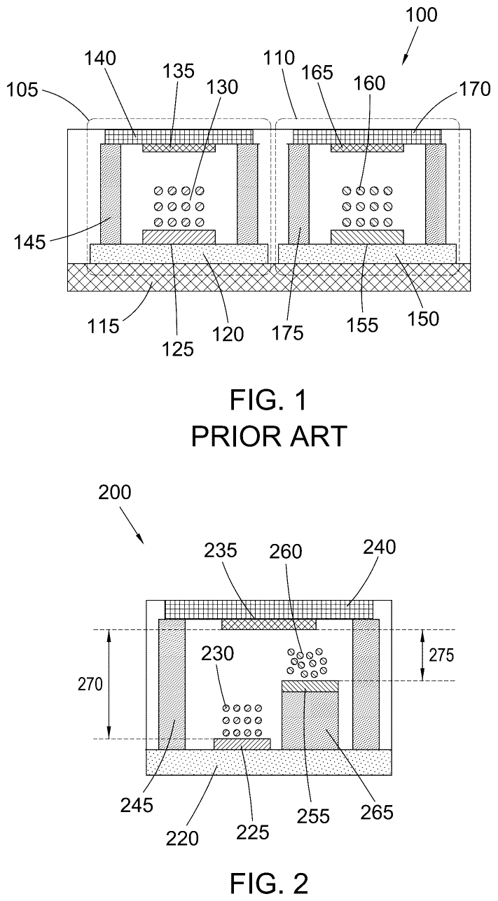

FIG. 1 depicts a block diagram of a known illumination assembly 100 comprising a flood illumination apparatus 105 and a structured light illumination apparatus 110.

The flood illumination apparatus 105 comprises a first substrate 120. The first substrate 120 may, for example, be a PCB substrate or a silicon substrate. A first VCSEL array 125 is mounted on the first substrate 120. Although not shown, one or more electrical connections may be formed between the first VCSEL array 125 and the first substrate 120. The flood illumination apparatus 105 also comprises a first spacer 145. The spacer holds a first glass substrate 140 at a defined distance from the first VCSEL array 125.

The first VCSEL array 125 comprises a plurality of VCSELs arranged in a regular periodic array, which for purposes of illustration is graphically represented as VCSEL arrangement 130. That is, VCSEL arrangement 130 represents the arrangement of VCSELs in the first VCSEL array 125.

A first micro lens array (MLA) 135 is provided on the first glass substrate 140. The first MLA 135 may, for example, be formed by a process of replication, nano-imprinting, or by otherwise depositing or adhering the first MLA 135 to the first glass substrate 140.

In the example known illumination assembly 100, the first MLA 135 of the flood illumination apparatus 105 comprises micro lenses that are arranged in an irregular arrangement, such that a periodicity of the micro lenses of the first MLA 135 does not match that of the first VCSEL array 125.

The structured light illumination apparatus 110 comprises a second substrate 150. The second substrate 150 may, for example, be a PCB substrate or a silicon substrate. A second VCSEL array 155 is mounted on the second substrate 150. Although not shown, one or more electrical connections may be formed between the second VCSEL array 155 and the second substrate 150. The flood illumination apparatus 110 also comprises a second spacer 175. The second spacer holds a second glass substrate 170 at a defined distance from the second VCSEL array 155.

The second VCSEL array 155 comprises a plurality of VCSELs arranged in a regular periodic array, which for purposes of illustration is graphically represented as VCSEL arrangement 160. That is, VCSEL arrangement 160 represents the arrangement of VCSELs in the second VCSEL array 155.

A second MLA 165 is provided on the second glass substrate 170. The second MLA 165 may, for example, be formed by a process of replication, nano-imprinting, or by otherwise depositing or adhering the second MLA 165 to the second glass substrate 170.

In the example known illumination assembly 100, the second MLA 165 of the structured light illumination apparatus 110 comprises micro lenses that are arranged in a regular periodic arrangement, such that a periodicity of the micro lenses of the second MLA 165 matches that of the second VCSEL array 155.

Both of the first substrate 120 and the second substrate 150 are mounted on a further substrate 115 which may, for example, be a PCB.

An overall size of the illumination assembly 100 is relatively large, because there is no integration of the flood illumination apparatus 105 and the structured light illumination apparatus 110, beyond sharing the further substrate 115. Such a large illumination assembly 100 may incur substantial material costs.

Furthermore, a footprint required for the illumination assembly 100, e.g. a footprint on a printed circuit board in an electronic device, may also be relatively large, thus incurring high overall system costs.

Due to the separate flood illumination apparatus 105 and structured light illumination apparatus 110, an assembly complexity of illumination assembly 100 may be relatively high. For example, it may be necessary to adhere to strict design tolerances in relation to relative placement of the separate flood illumination apparatus 105 and structured light illumination apparatus 110.

Due to the separate first MLA 135 and second MLA 165, a housing of an electronic device implementing the illumination assembly 100 may require a separate aperture corresponding to each MLA. 135, 165.

FIG. 2 depicts a block diagram of an illumination apparatus 200 according to an embodiment of the disclosure.

The illumination apparatus 200 comprises a substrate 220. The substrate 220 may, for example, be a PCB substrate or a silicon substrate. First radiation-emitting elements 225 are mounted on the substrate 220.

Although not shown, one or more electrical connections may be formed between the first radiation-emitting elements 225 and the substrate 220. The illumination apparatus 200 also comprises a first spacer 245. The first spacer 245 holds a glass substrate 240 at a defined distance from the first radiation-emitting elements 225.

A micro lens array MLA 235 is provided on the glass substrate 240. The MLA 235 may, for example, be formed by a process of replication, nano-imprinting, or by otherwise depositing or adhering the MLA 235 to the first glass substrate 240.

The first radiation-emitting elements 225 are provided as an array of periodically arranged radiation-emitting elements, which for purposes of illustration is graphically represented as radiation-emitting element arrangement 230.

In embodiments, the first radiation-emitting elements 225 are provided as an array of VCSELs.

The first radiation-emitting elements 225 are disposed at a first distance 270 from the MLA 235 and configured to generate, in cooperation with the MLA 235, a structured light pattern. The first spacer 245 defines the first distance 270. The first distance 270 may be defined by Equation (1).

That is, in the example illumination apparatus 200, the MLA 235 comprises micro lenses that are arranged in a regular arrangement, such that a periodicity of the micro lenses of the MLA 235 matches that of the first radiation-emitting elements 225.

That is, the first radiation-emitting elements 225 may be arranged with a first pitch corresponding to an integer N multiple or a 1/N multiple of a pitch of the MLA 235.

The illumination apparatus 200 comprises a second spacer 265.

Second radiation-emitting elements 255 are mounted on the second spacer 265.

Although not shown, one or more electrical connections may be formed between the second radiation-emitting elements 255 and the substrate 220, via the second spacer 265.

The second spacer 265 holds the second radiation-emitting elements 255 at a second distance 275 from the MLA 235.

The first distance 270 is greater than the second distance 275. By having the first distance 270 greater than the second distance 275, any substantial fringes and/or high contrast regions in the beam for flood illumination can be avoided, improving a uniformity of the flood illumination.

That is, first distance 270 may be selected such that the relationship between P, D and N for the first radiation-emitting elements 225 as defined by Equation (1) is met. Therefore, the first radiation-emitting elements 225 disposed at a first distance 270 from the MLA 235 may be configured to generate, in cooperation with the MLA 235, a structured light pattern comprising fringes and/or high contrast regions. By having the second distance 275 smaller than the first distance 270, the relationship between P, D and N defined by Equation (1) may be avoided for the second radiation-emitting elements, avoiding any substantial fringes and/or high contrast regions in the beam for flood illumination.

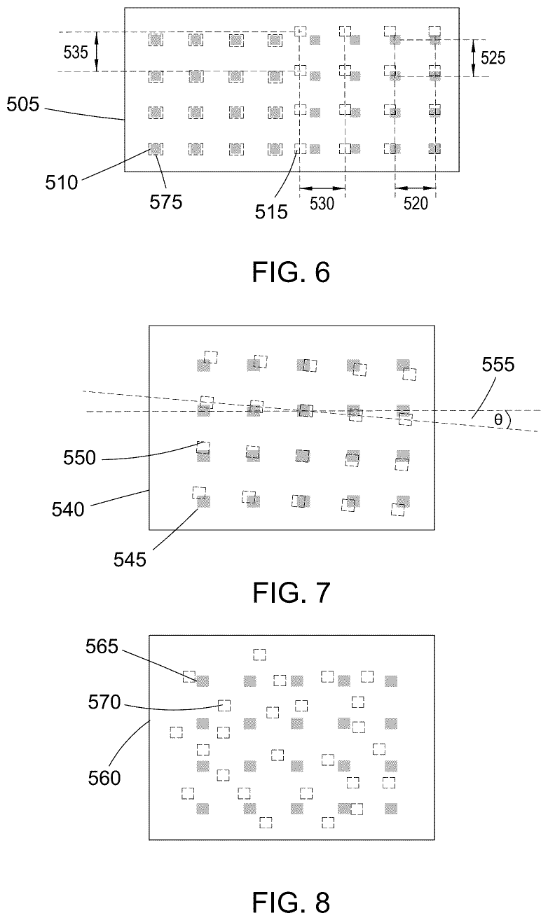

In the example embodiment of FIG. 2, the second radiation-emitting elements 255 may be provided as an array of irregularly arranged radiation-emitting elements, which for purposes of illustration is graphically represented as radiation-emitting element arrangement 260. As will be described in more detail below, in particular with reference to FIGS. 6, 7 and 8, the second radiation-emitting elements 255 may be provided in a variety or arrangements, such that the second radiation-emitting elements 255 are arranged to avoid matching any periodicity of the periodically arranged micro lenses and configured to generate, in cooperation with the MLA 240, a beam for flood illumination.

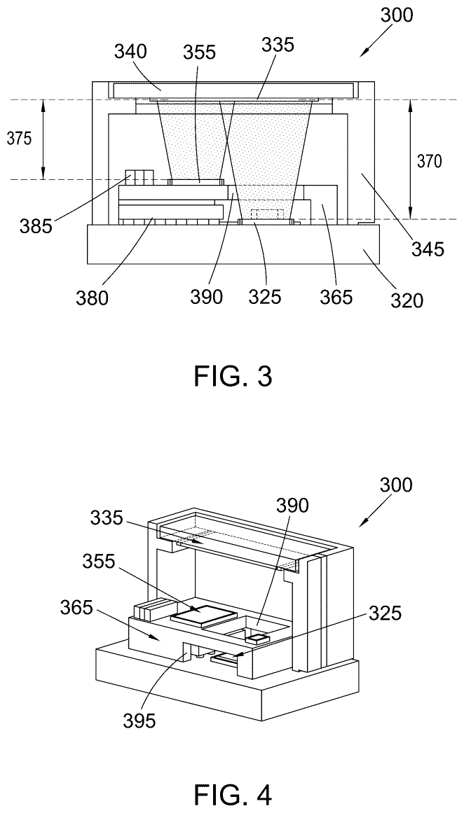

FIG. 3 depicts a block diagram of a cross-section of an illumination apparatus 300 according to an embodiment of the disclosure. FIG. 4 depicts a perspective, cut-away view of the illumination apparatus 300 of FIG. 3.

The illumination apparatus 300 comprises a substrate 320. The substrate 320 may, for example, be a PCB substrate or a silicon substrate. First radiation-emitting elements 325 are mounted on the substrate 320.

Although not shown, one or more electrical connections may be formed between the first radiation-emitting elements 325 and the substrate 320. The illumination apparatus 300 also comprises a first spacer 345. The first spacer 345 holds a glass substrate 340 at a defined distance from the first radiation-emitting elements 325.

A micro lens array MLA 335 is provided on the glass substrate 340. The MLA 335 may, for example, be formed by a process of replication, nano-imprinting, or by otherwise depositing or adhering the MLA 335 to the glass substrate 340.

The first radiation-emitting elements 325 are provided as an array of periodically arranged radiation-emitting elements. In embodiments, the first radiation-emitting elements 325 are provided as an array of VCSELs.

The first radiation-emitting elements 325 are disposed at a first distance 370 from the MLA 335 and configured to generate, in cooperation with the MLA 335, a structured light pattern. The first spacer 345 defines the first distance 370.

That is, in the example illumination apparatus 300, the MLA 335 comprises micro lenses that are arranged in a regular arrangement, such that a periodicity of the micro lenses of the MLA 335 matches that of the first radiation-emitting elements 325, or is an integer multiple of a periodicity of the first radiation-emitting elements 325.

The illumination apparatus 300 comprises a second spacer 365.

Second radiation-emitting elements 355 are mounted on the second spacer 365.

Although not shown, one or more electrical connections may be formed between the second radiation-emitting elements 355 and the substrate 320, via the second spacer 365.

The second spacer 365 holds the second radiation-emitting elements 355 at a second distance 375 from the MLA 335.

The second spacer 365 is a thermally conductive spacer. The plurality of second radiation-emitting elements 355 are disposed in heat-transfer relation to the second spacer 365. As such, heat generated in the second radiation-emitting elements 355 is use may be conducted by the second spacer 365 away from the second radiation-emitting elements 355.

In the example of FIGS. 3 and 4, the second spacer 365 is formed from a ceramic material. In some embodiments, the second spacer 365 may be formed from a High-Temperature Co-fired Ceramic (HTCC).

The first distance 370 is greater than the second distance 375.

In the example embodiment of FIG. 3, the second radiation-emitting elements 355 may be provided as an array of irregularly arranged radiation-emitting elements 355. As will be described in more detail below, in particular with reference to FIGS. 6, 7 and 8, the second radiation-emitting elements 355 may be provided in a variety of arrangements, such that the second radiation-emitting elements 355 are arranged to avoid matching a periodicity of the periodically arranged micro lenses. As such, the second radiation-emitting elements 355 are configured to generate, in cooperation with the MLA 340, a beam for flood illumination.

In the example Illumination apparatus 300, the second spacer 365 extends over an integrated circuit (IC) 380, such that the second radiation-emitting elements 355 are disposed over the IC 380. By extending the second spacer 365 over the IC 380, a compact and highly integrated illumination apparatus 300 may be assembled, e.g. by effectively stacking the second radiation-emitting elements 355 over the IC 380.

Although in the example of FIG. 3 a gap is depicted between the second spacer 365 and the IC 380, in other embodiments the second spacer 365 and the IC 380 may collectively provide a thermally conductive path for sinking heat from the second radiation-emitting elements 355 into the substrate 320. In some embodiments, the second spacer 365 and the IC 380 may be coupled by a thermal interface material, for example a thermal paste or silicone thermal compound. The IC 380 may be configured to drive the array of periodically arranged first radiation-emitting elements 325 and/or the plurality of second radiation-emitting elements 355.

The second spacer 365 may also be configured to support one or more further electrical components. In the example of FIG. 3, a capacitor 385 is depicted as mounted on an upper surface of the second spacer 265. The second spacer 265 may comprise various metal contacts and/or layers for supporting electrical connectivity to the capacitor 385, as described in more detail below.

The second spacer 365 comprises an aperture 390 disposed over the array of first radiation-emitting elements 325, such that radiation emitted by the first radiation-emitting elements 325 propagates through the aperture 390 towards the MLA 335.

The second spacer 365 may also comprise one or more further apertures, such as further aperture 395, which may improve heat dissipation from the IC 380 and/or the first radiation-emitting elements 325.

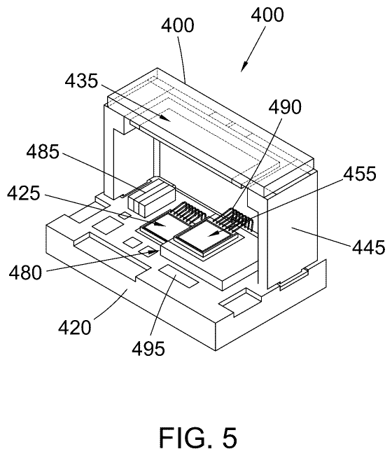

FIG. 5 depicts a perspective, cut-away view of an illumination apparatus 400 according to a further embodiment of the disclosure. Similar to the illumination apparatus 300 of FIGS. 3 and 4, the illumination apparatus 400 comprises a substrate 420 with first radiation-emitting elements 425 mounted on the substrate 420, and a first spacer 445 holding a glass substrate 440 at a defined distance from the first radiation-emitting elements 425. A micro lens array MLA 435 is provided on the glass substrate 440, and the first radiation-emitting elements 425 are disposed at a first distance from the MLA 435 and configured to generate, in cooperation with the MLA 435, a structured light pattern. The first spacer 445 defines the first distance.

The illumination apparatus 500 comprises an IC 480.

Second radiation-emitting elements 455 are mounted on the IC 480.

The first and second radiation-emitting elements 425, 455 are VCSELs.

The IC 480 may configured to drive the array of periodically arranged first radiation-emitting elements 425 and/or the plurality of second radiation-emitting elements 355.

The IC 480 holds the second radiation-emitting elements 455 at a second distance from the MLA 435. The first distance is greater than the second distance.

The second radiation-emitting elements 455 may be provided as an array of irregularly arranged radiation-emitting elements. As will be described in more detail below, in particular with reference to FIGS. 6, 7 and 8, the second radiation-emitting elements 455 may be provided in a variety or arrangements, such that the second radiation-emitting elements 455 are arranged to avoid matching any periodicity of the periodically arranged micro lenses and configured to generate, in cooperation with the MLA 440, a beam for flood illumination.

The IC 480 is thermally conductive. The plurality of second radiation-emitting elements 455 are disposed in heat-transfer relation to the IC 480. As such, heat generated in the second radiation-emitting elements 455 is use may be conducted by the IC 480 away from the second radiation-emitting elements 455.

That is, in contrast to illumination apparatus 300 of FIGS. 3 and 4 wherein a dedicated second spacer 365 is provided, in the illumination apparatus 400 of FIG. 5 the IC 480 is the spacer.

One or more intermediate layers may be provided between the IC 480 and the plurality of second radiation-emitting elements 455, such as a PCB layer, or a thermal interface material, for example a thermal paste or silicone thermal compound.

The substrate 420 may also be configured to support one or more further electrical components. For purposes of example only, in FIG. 5, a capacitor 485 is depicted as mounted on the substrate 420. The substrate 420 may comprise various metal contacts and/or layers for supporting electrical connectivity to the capacitor 485.

The plurality of second radiation emitting elements 455 are provided as a monolithic device, e.g. on a same die. Substrate 420 is provided with bond pads 490, and bond wires 495 provide electrically conductive connections between the substrate 420 and the plurality of second radiation emitting elements 455.

As described above, the plurality of second radiation-emitting elements 255, 355, 455 in each embodiment of the disclosure are arranged such that they do not match a pitch of the MLA 235, 335, 435 to achieve a relatively uniform beam of illumination suitable for flood illumination, e.g. without substantial fringes and/or high contrast regions. FIGS. 6 to 8 depict several ways of achieving this. The techniques described with reference to FIGS. 6 to 8 may be used either alone or in combination.

FIG. 6 depicts an MLA 505 comprising an array of micro lenses 510 arranged in a regular periodic array with a first pitch 520 in an ‘x’-direction and a second pitch 525 in a ‘y’-direction orthogonal to the x-direction.

For purposes of example, a first array of radiation-emitting elements 575, e.g. VCSELs, is depicted. The first array of radiation-emitting elements 575 are periodically arranged and disposed at a distance from the MLA 505 to generate, in cooperation with the MLA 505, a structured light pattern, e.g. a dot pattern. It can be seen that, for purposes of example, the first array of radiation-emitting elements 575 is arranged with the same pitch as the array of micro lenses 510. In other examples, the first array of radiation-emitting elements 575 is arranged with a pitch corresponding to an integer N multiple or a 1/N multiple of a pitch of the MLA 505.

Also depicted is a second array of radiation-emitting elements 515, e.g. VCSELs. The second array of radiation-emitting elements 515 are also arranged in a regular periodic array. However, the second array of radiation-emitting elements are arranged with a third pitch 530 in the ‘x’-direction that is different to the first pitch 520. The second array of radiation-emitting elements 515 are also arranged with a fourth pitch 535 in the ‘y’-direction that is different to the second pitch 525.

That is, the second array of radiation-emitting elements 515 are periodically arranged with third and fourth pitches 530, 535 different to the first and second pitches 520, 525 of the MLA 505, e.g. the pitches are different in both a first direction and a second direction orthogonal to the first direction.

For simplicity of illustration, the first array of radiation-emitting elements is not depicted in FIGS. 7 and 8, and only arrangements correspond to different arrangements of the plurality of second radiation-emitting elements is depicted.

FIG. 7 depicts an MLA 540 comprising an array of micro lenses 545 arranged in a regular periodic array with a first pitch in an ‘x’-direction and a second pitch in a ‘y’-direction orthogonal to the x-direction.

Also depicted is an array of radiation-emitting elements 550, e.g. VCSELs. The second radiation-emitting elements 550 are also arranged in a regular periodic array. However, array of second radiation-emitting elements 550 is rotated by an angle e relative to the array of micro lenses 545. As such, the array of second radiation-emitting elements 550 is periodically arranged with a third pitch different to the first pitch and the second pitch of the MLA 540, e.g. different in both a first direction and a second direction orthogonal to the first direction.

FIG. 8 depicts an MLA 560 comprising an array of micro lenses 565 arranged in a regular periodic array with a first pitch in an ‘x’-direction and a second pitch in a ‘y’-direction orthogonal to the x-direction. Also depicted is a plurality of second radiation-emitting elements 570. The second radiation-emitting elements 570 are randomly distributed, such that the second radiation-emitting elements 570 are distributed to avoid matching any periodicity, e.g. pitch, of the periodically arranged micro lenses 565.

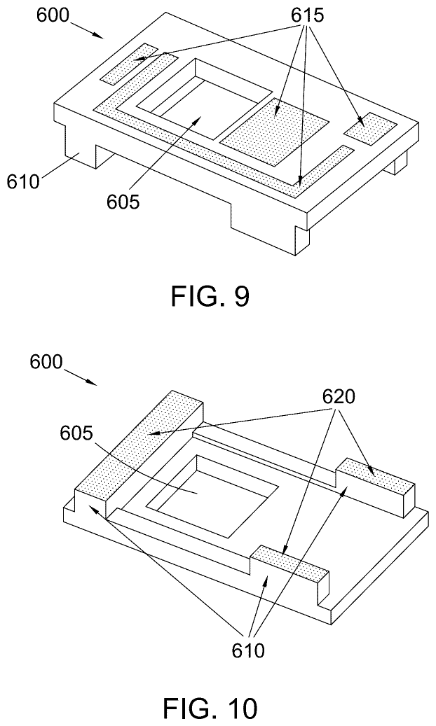

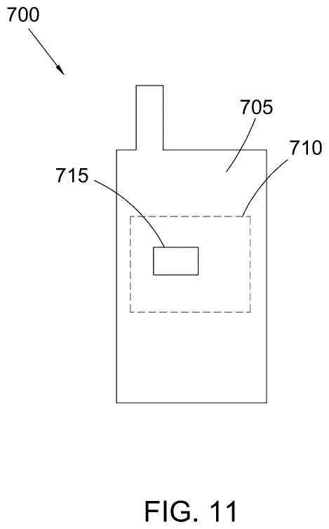

FIG. 9 depicts a perspective view of a spacer 600 for an illumination apparatus, according to an embodiment of the disclosure. The spacer 600 may be used as the second spacer 365 in the illumination apparatus 300 of FIGS. 3 and 4. FIG. 10 depicts a further perspective view of the spacer 600.

The example spacer 600 is formed from a ceramic material. In some examples, the spacer 600 is formed from a High-Temperature Co-fired Ceramic (HTCC).

An upper surface of the spacer 600, e.g. a surface to which the second radiation-emitting elements 355 are coupled as depicted in FIGS. 3 and 4, comprises a plurality of electrically conductive contacts 615. The electrically conductive contacts 615 may be provided in a metal layer formed or deposited on the spacer 600.

In use, a substrate comprising radiation-emitting elements, e.g. second radiation-emitting elements 355, may be conductively coupled to one or more of the electrically conductive contacts 615. Similarly, one or more components, such as capacitor 385, may be coupled to one or more of the electrically conductive contacts 615.

The spacer comprises a plurality of supports 610 that, in use, define a height of the upper surface of the spacer 600 from a base substrate 320 to define the second distance 375.

In FIG. 10, a lower surface of the spacer 600 is depicted. Each support 610 comprises electrically conductive contacts 620. One or more vias may extend through the spacer 600, thus connecting electrically conductive contacts 620 on the lower surface to electrically conductive contacts 615 on the upper surface.

Also depicted in FIG. 10 is an aperture 605 in the spacer 600. In use, the aperture 605 may be disposed over the array of first radiation-emitting elements, such that radiation emitted by the first radiation-emitting elements propagates through the aperture 605 towards an MLA. That is, the aperture 605 is equivalent to the aperture 390 of the second spacer 365 of FIG. 3.

FIG. 11 depicts a device 700 comprising an illumination apparatus 710 according to an embodiment of the disclosure.

For purposes of example only, the device 700 is a smartphone.

The illumination apparatus 710 may be an illumination apparatus 200, 300, 400 as described above.

The device 700 comprises a housing 705 configured to house various components of the device, including the illumination apparatus 710. The illumination apparatus 705 is configured to emit the structured light pattern and the beam for flood illumination through a single aperture 715 in the housing 705. This is in contrast to other known devices, wherein either a first aperture is provided for emitting the structured light pattern and a second aperture is provided for emitting the beam for flood illumination, or a much larger aperture is provided for emission of both the structured light pattern and the beam for flood illumination.

Although the disclosure has been described in terms of embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### REFERENCE NUMERALS

100 illumination assembly
105 flood illumination apparatus
110 structured light illumination apparatus
115 further substrate
120 first substrate
125 first VCSEL array
130 VCSEL arrangement
135 first micro lens array
140 first glass substrate
145 first spacer
150 second substrate
155 second VCSEL array
160 VCSEL arrangement
165 second micro lens array
170 second glass substrate
175 second spacer
200 illumination apparatus
220 substrate
225 first radiation-emitting elements
230 radiation-emitting element arrangement
235 micro lens array
240 glass substrate
245 first spacer
255 second radiation-emitting elements
260 radiation-emitting element arrangement
265 second spacer
270 first distance
275 second distance
300 illumination apparatus
320 substrate
325 radiation-emitting elements
335 micro lens array
340 glass substrate
345 spacer
355 radiation-emitting elements
365 spacer
370 first distance
375 second distance
380 integrated circuit
385 capacitor
390 aperture
395 further aperture
400 illumination apparatus
420 substrate
425 radiation-emitting elements
435 micro lens array
440 glass substrate
445 spacer
455 radiation-emitting elements
480 integrated circuit
485 capacitor
490 bond wires
495 bond pad
505 micro lens array
510 micro lens
515 radiation-emitting element
520 first pitch
525 second pitch
530 third pitch
535 fourth pitch
540 micro lens array
545 micro lens
550 radiation-emitting element
555 angle
560 micro lens array
565 micro lens
570 radiation-emitting element
575 radiation-emitting elements
600 spacer
605 aperture
610 supports
615 conductive contacts
620 conductive contacts
700 device
705 housing
710 illumination apparatus
715 aperture

1. An illumination apparatus comprising:
a micro lens array (MLA) comprising periodically arranged micro lenses;
an array of periodically arranged first radiation-emitting elements disposed at a first distance from the MLA and configured to generate, in cooperation with the MLA, a structured light pattern; and
a plurality of second radiation-emitting elements disposed at a second distance from the MLA and arranged to avoid matching any periodicity of the periodically arranged micro lenses and configured to generate, in cooperation with the MLA, a beam for flood illumination,
the first distance being greater than the second distance, and
wherein the array of periodically arranged first radiation-emitting elements comprises radiation-emitting elements having a first pitch corresponding to an integer N multiple or a 1/N multiple of a second pitch of the MLA.

2. The illumination apparatus of claim 1, comprising a thermally conductive spacer, wherein the plurality of second radiation-emitting elements are disposed in heat-transfer relation to the spacer, the spacer defining the second distance.

3. The illumination apparatus of claim 2, wherein the spacer is formed from a ceramic material.

4. The illumination apparatus of claim 2, wherein the spacer comprises an aperture disposed over the array of first radiation-emitting elements such that radiation emitted by the first radiation-emitting elements propagates through the aperture towards the MLA.

5. The illumination apparatus of claim 2, wherein:
the spacer extends over an integrated circuit (IC), such that the plurality of second radiation-emitting elements are disposed over the IC; or
the spacer is an IC.

6. The illumination apparatus of claim 5, wherein the IC is configured to drive the array of periodically arranged first radiation-emitting elements and/or the plurality of second radiation-emitting elements.

7. The illumination apparatus of claim 2 comprising a substrate, wherein the spacer provides at least one electrical connection between at least one electrically conductive element formed on the substrate and the plurality of second radiation-emitting elements.

8. (canceled)

9. The illumination apparatus of claim 1, wherein the plurality of second radiation-emitting elements are periodically arranged with a third and/or fourth pitch different to the second pitch of the MLA in at least a first direction and a second direction orthogonal to the first direction.

10. The illumination apparatus of claim 1, wherein the plurality of second radiation-emitting elements are arranged in a regular periodic array that is rotated relative to the periodically arranged micro lenses of the MLA.

11. The illumination apparatus of claim 1, wherein the array of periodically arranged first radiation-emitting elements disposed at the first distance are configured to generate a structured light pattern comprising an array of dots or lines on a target.

12. The illumination apparatus of claim 1, wherein each radiation-emitting element is a Vertical Cavity Surface Emitting Laser (VCSEL).

13. The illumination apparatus of claim 1, wherein the plurality of second radiation emitting elements are provided as a monolithic device.

14. (canceled)

15. (canceled)

16. An arrangement comprising:
an illumination apparatus comprising:
a micro lens array (MLA) comprising periodically arranged micro lenses;
an array of periodically arranged first radiation-emitting elements disposed at a first distance from the MLA and configured to generate, in cooperation with the MLA, a structured light pattern; and
a plurality of second radiation-emitting elements disposed at a second distance from the MLA and arranged to avoid matching any periodicity of the periodically arranged micro lenses and configured to generate, in cooperation with the MLA, a beam for flood illumination,
the first distance being greater than the second distance, and
wherein the array of periodically arranged first radiation-emitting elements comprises radiation-emitting elements having a first pitch corresponding to an integer N multiple or a 1/N multiple of a second pitch of the MLA;
a housing defining a device, wherein the housing encloses the illumination apparatus,
wherein the illumination apparatus is configured to emit the structured light pattern and the beam for flood illumination through a single aperture or window in the housing.

17. The arrangement of claim 16, wherein the device is one of: a smartphone; a tablet device; a communications device; a personal computer; a wearable electronic device; an e-lock device; a security device; a biometric identification device; or a gaming device.
